(19) United States
(12) Patent Application Publication
(10) Pub. No.: US 2011/0199496 A1
(43) Pub. Date: Aug. 18, 2011

(54) IMAGE CAPTURING APPARATUS, IMAGE CAPTURING CONTROL METHOD, AND STORAGE MEDIUM

(75) Inventors: Jun MURAKI, Tokyo (JP); Hiroshi SHIMIZU, Tokyo (JP); Hiroyuki HOSHINO, Tokyo (JP); Erina ICHIKAWA, Tokyo (JP)

(73) Assignee: CASIO COMPUTER CO., LTD., Tokyo (JP)

(21) Appl. No.: 13/020,940

(22) Filed: Feb. 4, 2011

(30) Foreign Application Priority Data
Feb. 16, 2010 (JP) 2010-031134
Mar. 19, 2010 (JP) 2010-064710

(51) Int. Cl. H04N 5/225

(52) U.S. Cl. 348/218.1; 348/E05.025

(57) ABSTRACT

An image capturing apparatus 1 includes an image sensor 15, a microphone 24, and a CPU 20. The microphone 24 inputs sound. The CPU 20 acquires data of a plurality of images of a subject continuously captured by the image sensor 15 as data of a first image group at a first frame rate in a first recording period. Also, the CPU 20 acquires data of a plurality of images of a subject captured by the image sensor 15 as data of a second image group at a second frame rate, which is higher than the first frame rate, in a second recording period. Furthermore, the CPU 20 generates data of moving images that can be played back at the first frame rate from sound data inputted by the microphone 24, data of the first image group acquired at the first frame rate, and data of the second image group acquired at the second frame rate.

This application is based on and claims the benefit of priority from Japanese Patent Application Nos. 2010-031134 and 2010-064710, respectively filed on Feb. 16, 2010, and Mar. 19, 2010, the content of which is incorporated herein by reference.

### BACKGROUND OF THE INVENTION

1. Field of the Invention

The present invention relates to an image capturing apparatus, an image capturing control method, and a storage medium capable of normal movie recording and slow motion movie recording.

2. Related Art

Conventionally, there have been provided techniques to record data of moving images in a storage medium by capturing images of a subject in a field of view at a predetermined interval and storing data of the captured images sequentially in the storage medium (See Japanese Patent Application Publication No. 2005-109984, Japanese Patent Application Publication No. H10-51735, and Japanese Patent Application Publication No. 2002-320203).

Here, each of the images captured in sequence at a predetermined interval is hereinafter defined as a “frame image”.

A rate of transmission or processing of data of moving images constituted by such a plurality of frame images is generally represented using frame rate. This means that a frame rate represents an amount of data transmitted or processed per unit time by the number of frames. In the present specification, one second is employed as the unit of time, and fps (Frames per Second) is employed as unit of frame rate.

As a conventional method of recording data of moving images, there is a method that records data of moving images captured at X fps (X being an arbitrary number) so that the data will be played back at X fps. Such a method is hereinafter defined as “normal movie recording”. Also, there is another conventional method that records data of moving images captured at Y fps so that the data will be played back at X fps (Y is an arbitrary number greater than X). Such a method is hereinafter defined as “slow motion movie recording”.

In the following, a difference between normal movie recording and slow motion movie recording will be explained in detail with reference to FIGS. 8 and 9.

FIG. 8 is a timing chart illustrating a relation between data of captured frame images and data of frame images recorded as data of moving images, in a case in which the normal movie recording is carried out by a conventional image capturing apparatus.

FIG. 8A is a timing chart illustrating an example of data of frame images outputted from an image capturing device. In FIG. 8A, one box denotes data of one frame image outputted from the image capturing device. In FIG. 8A, though frame numbers are not shown, data of the leftmost frame image has a frame number of 0, and in a direction from left to right in the figure, i.e. in order of output from the image capturing device, data of each frame image has a frame number that is incremented by 1, as in 1, 2, 3, and so forth.

In the example of FIG. 8A, the frame rate of output from the image capturing device (hereinafter defined as “capture rate”) is assumed to be 150 fps, i.e. five times faster than an ordinary capture rate of 30 fps, in order to correspond with the example of FIG. 9A, which will be described later.

FIG. 8B is a timing chart illustrating an example of data of frame images recorded in a storage medium in a case in which the normal movie recording is carried out. In FIG. 8B, one box denotes data of one frame image recorded in the storage medium. A number described in a box indicates a frame number assigned to the data of a frame image denoted by the box.

As shown in FIG. 8B, from data of frame images outputted from the image capturing device shown in FIG. 8A, data of frame images at 5-frame intervals (respectively denoted by the black boxes in FIG. 8A), i.e. data of frame images for the frame numbers of 0, 5, 10, 15, 20, 25, and so forth are acquired, and then recorded in the storage medium. This means that by acquiring data of frame images at 5-frame intervals from data of frame images captured at a capture rate of 150 fps, data of moving images captured at 30 fps is acquired. The “data of moving images captured at 30 fps” acquired in this way is recorded in the storage medium at a frame rate of 30 fps.

Hereinafter, the frame rate when data of moving images is recorded in a storage medium is defined as “recording rate”. Furthermore, the frame rate when data of moving images recorded in a storage medium is played back is hereinafter defined as “playback rate”.

In the case of FIG. 8B, the recording rate is 30 fps. Therefore, by setting playback rate to 30 fps the same as the recording rate, the normal movie recording that records the “data of moving images captured at 30 fps” so that the data will be played back at 30 fps is realized.

FIG. 9 is a timing chart illustrating a relation between data of captured frame images and data of frame images recorded as data of moving images in a case in which the slow motion movie recording is carried out by the conventional image capturing apparatus.

FIG. 9A is a timing chart illustrating an example of data of frame images outputted from an image capturing device, identical to that of the example of FIG. 8A.

FIG. 9B is a timing chart illustrating an example of data of frame images recorded in a storage medium in a case in which the slow motion movie recording is carried out.

In FIG. 9B, one box denotes data of one frame image recorded in the storage medium. A number described in a box indicates a frame number assigned to data of a frame image denoted by the box.

As shown in FIG. 9B, from data of frame images outputted from the image capturing device shown in FIG. 9A, i.e. data of frame images for the frame numbers 0, 1, 2, 3, 4, 5, and so forth is acquired, and then recorded in the storage medium. In this way, the data of all frame images captured at a capture rate of 150 fps is acquired as “data of moving images captured at 150 fps” and then recorded in the storage medium at a recording rate of 30 fps.

Here, by setting playback rate to 30 fps, which is equal to the recording rate, the slow motion movie recording that records “data of moving images captured at 150 fps” so that the data will be played back at 30 fps is realized.

However, conventionally, it has been difficult to record and play back sound data in the slow motion movie recording.

For example, it is assumed that data of moving images has been recorded in a storage medium by carrying out the slow motion movie recording and the normal movie recording continuously. In this case, if the data of moving images is played back at a constant playback rate, it is possible to have an effect of playing back in slow motion when the data recorded by the slow motion movie recording is played back, in comparison with when the data recorded by the normal movie recording is played back.

However, it is difficult to maintain continuity through the periods of playing back sound data recorded by the slow motion movie recording and of playing back sound data recorded by the normal movie recording. Therefore, generally, sound data is not recorded and played back in the slow motion movie recording.

### SUMMARY OF THE INVENTION

The present invention is conceived in view of the above problems, and it is an object of the present invention to maintain continuity in recording and playing back sound data in a case where the slow motion movie recording and the normal movie recording are carried out continuously.

In accordance with a first aspect of the present invention, there is provided an image capturing apparatus, including: an image capturing unit; a sound input unit that inputs sound; a first acquisition unit that acquires, as a first group of images, a plurality of images of a subject continuously captured by the image capturing unit within a first recording period at a first frame rate by skipping some of the plurality of images of a subject at a predetermined time interval; a second acquisition unit that acquires, as a second group of images, images of a subject continuously captured by the image capturing unit within a second recording period at a second frame rate; and a generating unit that generates moving images capable of being played back at the first frame rate based on the sound inputted by the sound input unit, the first group of images acquired by the first acquisition unit, and the second group of images acquired by the second acquisition unit.

In accordance with a second aspect of the present invention, there is provided an image capturing control method including: an image capturing step of capturing an image; a sound input step of inputting sound; a first acquisition step of acquiring, as a first group of images, a plurality of images of a subject continuously captured in the image capturing step within a first recording period at a first frame rate by skipping some of the plurality of images of a subject at a predetermined time interval; a second acquisition step of acquiring, as a second group of images, images of a subject continuously captured in the image capturing step within a second recording period at a second frame rate; and a generating step of generating moving images capable of being played back at the first frame rate based on the sound inputted in the sound input step, the first group of images acquired in the first acquisition step, and the second group of images acquired in the second acquisition step.

In accordance with a third aspect of the present invention, there is provided a storage medium having stored therein a program readable by a computer provided with an image capturing unit and a sound input unit that inputs sound, to cause the computer to function as: a first acquisition unit that acquires, as a first group of images, a plurality of images of a subject continuously captured by the image capturing unit within a first recording period at a first frame rate by skipping some of the plurality of images of a subject at a predetermined time interval; a second acquisition unit that acquires, as a second group of images, images of a subject continuously captured by the image capturing unit within a second recording period at a second frame rate; and a generating unit that generates moving images capable of being played back at the first frame rate based on the sound inputted by the sound input unit, the first group of images acquired by the first acquisition unit, and the second group of images acquired by the second acquisition unit.

### BRIEF DESCRIPTION OF THE DRAWINGS

FIG. 1 is a set of timing charts respectively illustrating relations between data of frame images captured and recorded as data of moving images and sound data when the normal movie recording and the slow motion movie recording are continuously carried out by an image capturing apparatus according to the present invention;

FIG. 2 is a block diagram showing a configuration of hardware of an image capturing apparatus according to a first embodiment of the present invention;

FIG. 3 is a functional block diagram showing a functional configuration to implement normal movie recording and slow motion movie recording from among functional configurations of the image capturing apparatus shown in FIG. 2;

FIG. 4 is a flowchart showing one example of flow of movie recording control processing executed by the image capturing apparatus shown in FIG. 2;

FIG. 5 is a flowchart showing one example of detailed flow of wait processing from among the movie recording control processing shown in FIG. 4;

FIG. 6 is a flowchart showing one example of detailed flow of normal movie recording control processing from among the movie recording control processing shown in FIG. 4;

FIG. 7 is a flowchart showing one example of detailed flow of slow motion movie recording control processing from among the movie recording control processing shown in FIG. 4;

FIG. 8 is a set of timing charts respectively illustrating a relation between data of frame images captured and recorded as data of moving images when the normal movie recording is carried out by a conventional image capturing apparatus;

FIG. 9 is a set of timing charts respectively illustrating a relation between data of frame images captured and recorded as data of moving images when the slow motion movie recording is carried out by a conventional image capturing apparatus;

FIG. 10 is a set of timing charts respectively illustrating relations between data of frame images captured and recorded as data of moving images and sound data when the normal movie recording and the slow motion movie recording are continuously carried out by an image capturing apparatus according to a second embodiment of the present invention;

FIG. 11 is a functional block diagram showing a functional configuration to implement normal movie recording and slow motion movie recording from among functional configurations of the image capturing apparatus according to the second embodiment of the present invention;

FIG. 12 is a flowchart showing one example of flow of the slow motion movie recording control processing executed by the image capturing apparatus shown in FIG. 11;

FIG. 13 is a diagram illustrating an example of a composite image generated by the slow motion movie recording control processing executed by the image capturing apparatus shown in FIG. 11; and

FIG. 14 is a diagram illustrating composite images generated by the slow motion movie recording control processing carried out by the image capturing apparatus shown in FIG. 11.

### DETAILED DESCRIPTION OF THE INVENTION

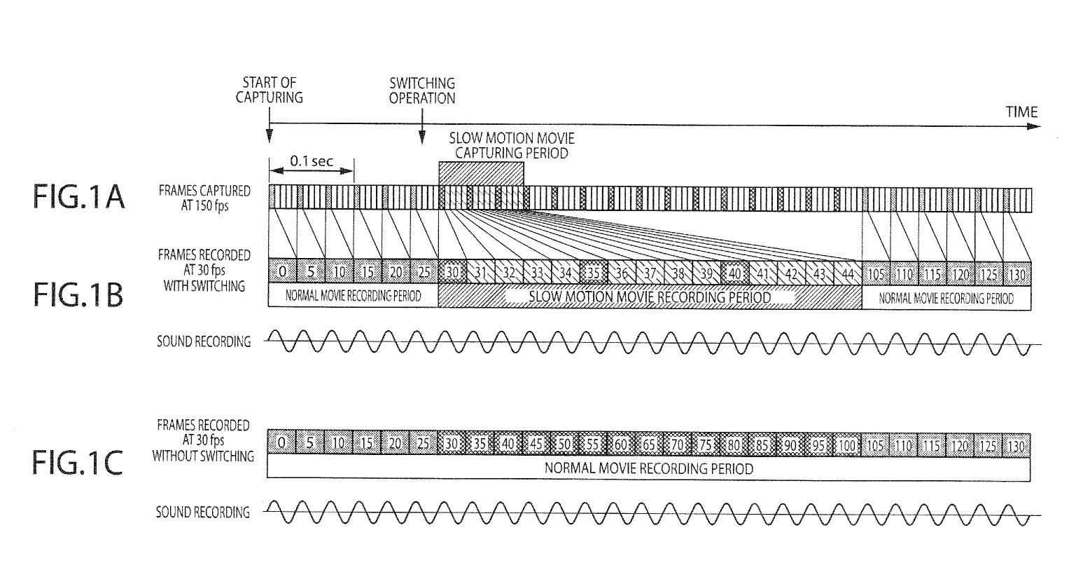

First, for ease of explanation of the present invention, a summary of the present invention is described with reference to FIG. 1.

FIG. 1 is a set of timing charts respectively illustrating relations between data of frame images captured and recorded as data of moving images and sound data in a case in which the normal movie recording and the slow motion movie recording are continuously carried out by an image capturing apparatus to which the present invention is applied.

FIG. 1A is a timing chart illustrating data of frame images outputted from an image capturing device. In FIG. 1A, a box denotes data of a frame image outputted from the image capturing device. In FIG. 1A, though frame numbers are not shown, data of the leftmost frame image has a frame number of 0, and in a direction from left to right, i.e. in order of output from the image capturing device, data of each frame image has a frame number that is incremented by 1, as in 1, 2, 3, and so forth.

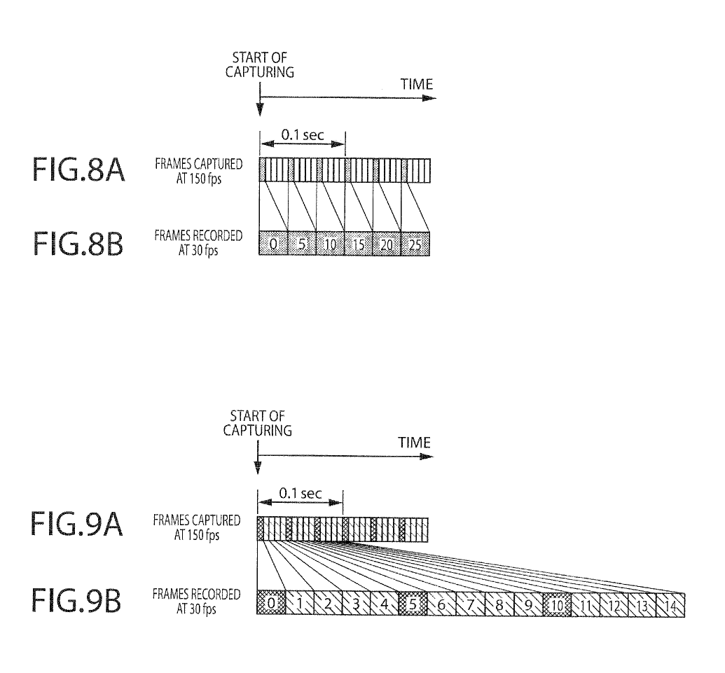

In the example of FIG. 1A, for ease of comparison with a conventional method, a capture rate of 150 fps is employed, which is identical to those of the examples of FIGS. 8A and 9A of the above mentioned conventional methods.

FIG. 1B is a timing chart illustrating data of frame images and sound recorded in the storage medium when the slow motion movie recording is carried out in between normal movie recordings. In FIG. 1B, a box denotes data of a frame image recorded in the storage medium. A number described in a box indicates a frame number assigned to the data of a frame image denoted by the box. The same applies to FIG. 1C, which will be described later.

In the case of normal movie recording, as shown in FIG. 1B, from data of frame images shown in FIG. 1A outputted from the image capturing device, data of frame images at 5-frame intervals (respectively denoted by the black boxes in FIG. 1A), i.e. data of frame images for the frame number 0, 5, 10, 15, 20, and 25 is acquired as a result of skipping 4 frame images of the frame images outputted from the image capturing device at predetermined time intervals respectively corresponding to the 5-frame intervals, and then recorded in the storage medium.

During such normal movie recording, a user can perform an operation to switch to the slow motion movie recording (hereinafter referred to as a “switching operation”).

When such a switching operation is performed, the normal movie recording is switched to the slow motion movie recording, and data of frame images is sequentially recorded in the storage medium under the following condition:

In the slow motion movie recording, the capture rate is five times faster than the recording rate. Here, the capture rate is 150 fps, and the recording rate is 30 fps. A slow motion movie capture period is 0.1 second per one switching operation, i.e. the number of frames to be recorded in the slow motion movie recording is 15.

More specifically, in the example of FIG. 1, the switching operation is performed at a moment when the frame image data for the frame number 26 is outputted from the image capturing device.

At the moment when the switching operation is performed, the recording of “data of moving images captured at 30 fps”, i.e. data of frame images at 5-frame intervals in the storage medium is in progress. More precisely, the recording of the data of the frame image for the frame number 25 in the storage medium is in progress.

Therefore, the normal movie recording is switched to the slow motion movie recording at the moment when the recording of the frame image data for the frame number 25 in the storage medium is complete. This means that the slow motion movie recording starts with the frame image data outputted from the image capturing device at the moment of switching, i.e. data of the frame image for the frame number 30, 5 frames after the frame image for the frame number 25.

As explained above, since a slow motion movie capture period is 0.1 second per one switching operation, i.e. the number of frames to be recorded in the slow motion movie recording is 15, as shown in FIG. 1B, data of the frame images for the frame numbers 30 to 44 become a target for the slow motion movie recording.

Therefore, when the slow motion movie recording is started, as shown in FIG. 1B, data of each frame image shown in FIG. 1A outputted from the image capturing device is recorded in the storage medium. This means that the data of all frame images for the frame numbers 30, 31, 32, 33, . . . and 44 is acquired as a target for recording , and then recorded in the storage medium.

Thus, the data of all frame images captured at the capture rate of 150 fps are acquired as “data of moving images captured at 150 fps” and recorded in the storage medium at the recording rate of 30 fps.

Here, by setting a playback rate to 30 fps, which is equal to the recording rate, the slow motion movie recording that records “data of moving images captured at 150 fps” so that the data will be played back played back at 30 fps is realized.

Herein, the slow motion movie capture period is intended to mean, as shown in FIG. 1A, a time period for the image capturing device to output data of frame images, which is a target for recording in the slow motion movie recording.

In the example of FIG. 1, the time period for the image capturing device to output data of 15 frame images for the frame numbers 30 to 44 is 0.1 second, since the capture rate is 150 fps. Therefore, the slow motion movie capture period in the example of FIG. 1 is 0.1 second.

However, the time period for data of 15 frame images for the frame numbers 30 to 44 to be recorded in the storage medium is 5 times longer than 0.1 second, which is the slow motion movie capture period, i.e. 0.5 seconds.

For this reason, 0.5 seconds after the slow motion movie recording has started, i.e. after the recording of the data of the frame image for the frame number 44 is complete, the slow motion movie recording switches to the normal movie recording.

At the moment when the normal movie recording is started again, as shown in FIG. 1B, the data of the frame image for the frame number 105 is outputted from the image capturing device. Therefore, from then, data of frame images for the frame numbers 105, 110, 115, 120, 125, 130, and so forth is acquired, and then recorded in the storage medium.

Thus, the movie recording starts with the normal movie recording and, when the switching operation is performed, switches to the slow motion movie recording. Then, data of 15 frame images outputted from the image capturing device within 0.1 second (the slow motion movie capture period) is recorded in the storage medium as moving images to be played back for 0.5 seconds (five times longer than 0.1 second, which is the slow motion movie capture period). After that, the movie recording switches to the normal movie recording again.

Such a time period for data of 15 frame images to be recorded in the storage medium by the slow motion movie recording in this way is a time period when data of frame images is not recorded by normal movie recording. In this sense, such a time period is hereinafter defined as “slow motion movie recording period” as shown in FIG. 1B.

The slow motion movie recording period is determined in accordance with the slow motion movie capture period. In the example of FIG. 1B, the slow motion movie recording period is 5 times longer than 0.1 second, which the slow motion movie capture period, i.e. 0.5 seconds.

Also, a time period, in which data of frame images is recorded by normal movie recording, is hereinafter defined as “normal movie recording period” as shown in FIG. 1B.

Here, sound data is continuously recorded in the storage medium regardless of whether in the slow motion movie recording period or in the normal movie recording period.

As a result, even if the slow motion movie recording is followed by the normal movie recording, continuity of recording and playing back of sound data is maintained.

FIG. 1C is a timing chart illustrating data of frame images and sound recorded in the storage medium without any switching operation, i.e. in a case in which the normal movie recording is consistently carried out.

In a case in which no switching operation has been performed, as shown in FIG. 1C, from data of frame images shown in FIG. 1A outputted from the image capturing device, data of frame images at 5-frame intervals (respectively denoted by the black boxes in FIG. 1A), i.e. data of frame images for the frame numbers 0, 5, 10, 15, 20, 25, 30, and so forth is acquired and then recorded in the storage medium.

In the case in which no switching operation has been performed, also from data of the frame images for the frame numbers 30 to 104, data of frame images at 5-frame intervals becomes a target for recording. Therefore, data of frame images for the frame numbers 30, 35, 40, . . . 90, 95, 100 is acquired and then recorded in the storage medium.

This means that, in the case in which no switching operation has been performed, as shown in FIG. 1C, the whole period of movie recording from the start to the termination becomes the normal movie recording period without having any slow motion movie recording period.

### First Embodiment

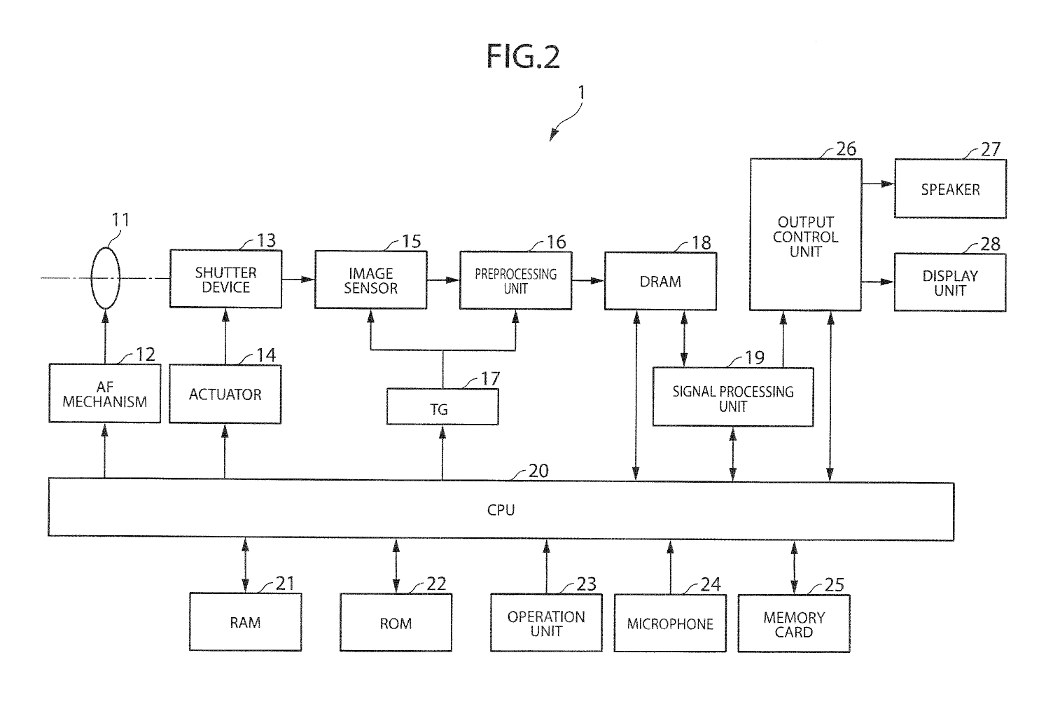

The following describes a first embodiment of the present invention with reference to the drawings starting from FIG. 2.

FIG. 2 is a block diagram showing a hardware configuration of the image capturing apparatus 1 according to the first embodiment of the present invention. The image capturing apparatus 1 can be configured by a digital camera, for example.

The image capturing apparatus 1 is provided with an optical lens device 11, an AF (Autofocus) mechanism 12, a shutter device 13, an actuator 14, an image sensor 15, a preprocessor 16, a TG (Timing Generator) 17, DRAM (Dynamic Random Access Memory) 18, a signal processing unit 19, a CPU (Central Processing Unit) 20, RAM (Random Access Memory) 21, ROM (Read Only Memory) 22, an operation unit 23, a microphone 24, a memory card 25, an output control unit 26, a speaker 27, and a display unit 28.

The optical lens device 11 is configured by a focus lens, a zoom lens, and the like, for example. The focus lens is a lens which can form an image of a subject on the receptive surface of the image sensor 15. The zoom lens is a lens which can freely change a focal point within a predetermined range.

The AF mechanism 12 moves the focus lens under the control of the CPU 20 to have the focus lens focus on a subject.

The shutter device 13 is constituted by shutter blades, for example. The shutter device 13 functions as a mechanical shutter that shuts off incident light to the image sensor 15. The shutter device 13 also functions as a diaphragm to adjust the amount of incident light to the image sensor 15.

The actuator 14 opens and shuts blades of the shutter device 13 under the control of the CPU 20.

The image sensor 15 is configured by an optoelectronic conversion device, AFE (Analog Front End), or the like.

The optoelectronic conversion device is configured by a CMOS (Complementary Metal Oxide Semiconductor) type optoelectronic conversion device, or the like, for example.

Incident light passing through the optical lens device 11 and the shutter device 13 forms an image of a subject on the optoelectronic conversion device. The optoelectronic conversion device optoelectronically converts (i.e. captures) the image of the subject into an image signal at a predetermined interval according to a clock pulse provided from the TG 17, stores the image signal for each pixel, and then outputs the image signal thus stored.

The AFE executes various types of signal processing such as A/D (Analog/Digital) conversion on the analog image signal. As a result of the various types of signal processing, a digital signal (hereinafter defined as “data”) is generated and outputted from the image sensor 15.

In this way, the image sensor 15 outputs data of frame images sequentially at a capture rate controlled by the TG 17.

The preprocessor 16 executes preprocessing such as black level adjustment on data of frame images outputted sequentially from the image sensor 15 according to a clock pulse provided from the TG 17, and then stores the preprocessed data in the DRAM 18.

The TG 17 provides a clock pulse to the image sensor 15 and the preprocessor 16 at predetermined time intervals in accordance with the capture rate under the control of the CPU 20.

As a result, the image sensor 15 and the preprocessor 16 operate at a rate equal to the capture rate. More specifically, in the example of FIG. 1 described above, since the capture rate is 150 fps, both the image sensor 15 and the preprocessor 16 operate at 150 fps.

The DRAM 18 temporarily stores data of a frame image provided from the preprocessor 16 or data of a frame image processed by the signal processing unit 19. Also, the DRAM 18 temporarily stores sound data provided from the microphone 24 via the CPU 20.

The signal processing unit 19 is configured by a DSP (Digital Signal Processor), for example, and executes various types of signal processing on data of a frame image provided from the preprocessor 16 or data of a frame image stored in the DRAM 18 under the control of the CPU 20.

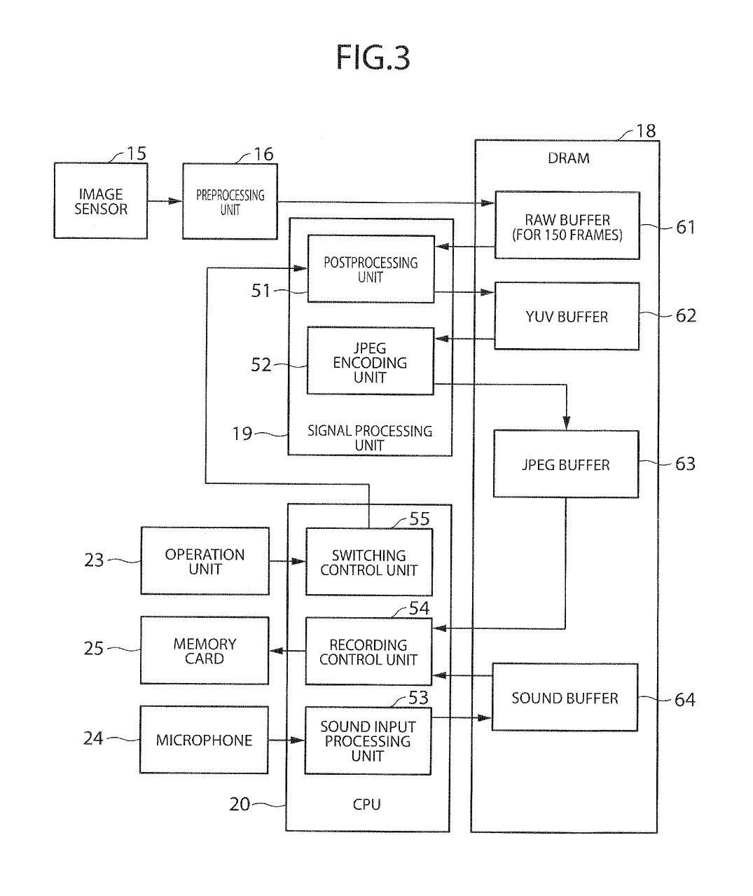

A specific example of signal processing executed by the signal processing unit 19 will be explained later with reference to the drawings starting from FIG. 3.

The CPU 20 controls the whole operation of the image capturing apparatus 1. The RAM 21 functions as a working area when the CPU 20 executes various processes. The ROM 22 stores a program and data required for the image capturing apparatus 1 to execute various processes. The CPU 20 executes various types of processing in collaboration with a program stored in ROM 22, utilizing the RAM 21 as a working area.

A specific example of processing executed by the CPU20 will be explained later with reference to the drawings starting from FIG. 3.

The output control unit 26 sequentially reads data of frame images stored in the DRAM 18, converts the data into image signals in a form appropriate for the display unit 28, and provides the image signal to the display unit 28 at a predetermined playback rate so as to cause the display unit 28 to display the frame images in accordance with the image signal. This means that the display unit 28 sequentially displays a plurality of frame images, thereby displaying moving images.

Also, the output control unit 26 reads sound data stored in DRAM 18, converts the data into a sound signal in a form appropriate for the speaker 27, and provides the signal to the speaker 27 so as to cause the speaker 27 to output sound in accordance with the sound signal.

The operation unit 23 receives inputs from various buttons operated by a user.

The operation unit 23 is provided with, for example, a power button, a cross button, an enter button, a menu button, a record button, a shutter button, and the like.

The operation unit 23 supplies to the CPU 20 a signal corresponding to an input received from a button operated by a user. The CPU 20 interprets the contents of the operation by the user based on the signal supplied from the operation unit 23, and executes processing corresponding to the contents of the operation.

For example, when the record button is pressed, the CPU 20 interprets the operation as an instruction to start movie recording and controls the signal processing unit 19 and the like, to start the normal movie recording.

During the normal movie recording, when the user performs the switching operation for movie recording by using the operation unit 23, the CPU 20 interprets the operation as an instruction to switch and controls the signal processing unit 19 and the like. The CPU 20 switches from the normal movie recording to the slow motion movie recording, and switches to the normal movie recording again when the slow motion movie recording terminates.

The microphone 24 inputs sound and outputs an analog sound signal. The CPU 20 executes appropriate processing such as A/D conversion on the analog sound signal, and stores sound data thus obtained to the DRAM 18.

The memory card 25 stores data of moving images and sound acquired as a result of the normal movie recording and slow motion movie recording under the control of the CPU 20. Also, the memory card 25 stores various data as required.

From among a plurality of functional configurations of the image capturing apparatus 1 having such a hardware configuration, FIG. 3 is a functional block diagram showing a functional configuration to implement normal movie recording and slow motion movie recording.

As shown in FIG. 3, in order to implement normal movie recording and slow motion movie recording, the signal processing unit 19 includes a postprocessing unit 51 and a JPEG (Joint Photographic Experts Group) encoding unit 52. The CPU 20 includes a sound input processing unit 53, a recording control unit 54, and a switching control unit 55. The DRAM 18 includes a RAW buffer 61, a YUV buffer 62, a JPEG buffer 63, and a sound buffer 64.

The postprocessing unit 51, the JPEG encoding unit 52, the sound input processing unit 53, the recording control unit 54, and the switching control unit 55 are not particularly limited to those described herein, and they may be configured by dedicated hardware or a combination of software and hardware.

The locations assigned to the postprocessing unit 51, the JPEG encoding unit 52, the sound input processing unit 53, the recording control unit 54, and the switching control unit 55 are not particularly limited to the example of FIG. 3 and may be arbitrary as long as the image capturing apparatus 1 can implement the functions of the postprocessing unit 51, the JPEG encoding unit 52, the sound input processing unit 53, the recording control unit 54, and the switching control unit 55 as a whole. Also, partitioning of functional blocks is not limited to the example of FIG. 3 and may be arbitrary.

As described above, both the image sensor 15 and the preprocessor 16 operate at a speed the same as the capture rate. In the present embodiment, it is assumed that the capture rate is 150 fps as described with the example of FIG. 1. Therefore, in the present embodiment, both the image sensor 15 and the preprocessor 16 operate at 150 fps.

Data of a frame image outputted from the preprocessing unit 16 is data of a RAW image (hereinafter defined as “RAW data”) and is written into the RAW buffer 61 of the DRAM 18.

In the present embodiment, the RAW buffer 61 is a ring buffer having capacity for RAW data of 150 frames as shown in FIG. 3.

Also, in the present embodiment, the destination address in the RAW buffer 61 where the output data from the preprocessing unit 16 is written is relocated in turn for each frame image.

The postprocessing unit 51 sequentially reads RAW data for each frame image from the RAW buffer 61, and executes image processing such as interpolation, color adjustment, brightness adjustment, and edge adjustment on the RAW data of a frame image thus read.

As a result, data (hereinafter defined as “YUV data”) including a luminance (Y) signal, a chrominance (U) signal indicative of a difference between luminance and blue color, and a chrominance (V) signal indicative of a difference between luminance and red color is acquired as the data of a frame image. The YUV data of a frame image is written into the YUV buffer 62 of the DRAM 18.

The activation timing of the postprocessing unit 51 is controlled by the switching control unit 55, which will be described later.

In a case in which the normal movie recording is carried out, for example, as described with reference to FIG. 1, data of frame images at 5-frame intervals is acquired from data of frame images outputted at 150 fps from the image sensor 15, and then recorded. Therefore, in the case in which the normal movie recording is carried out, the postprocessing unit 51 is activated by the switching control unit 55 at intervals required for RAW data of 5 frames to be written into the RAW buffer 61. This means that the postprocessing unit 51 sequentially reads RAW data of one frame from the RAW buffer 61 at 5-frame intervals, converts the RAW data into YUV data, and writes the YUV data into the YUV buffer 62. Thus, YUV data of frame images at 5-frame intervals, i.e. the YUV data of frame images for the frame numbers 0, 5, 10, 15, 20, and 25 in the example of FIG. 1B, is acquired and written into the YUV buffer 62.

On the other hand, in a case in which the slow motion movie recording is carried out, for example, as described with reference to FIG. 1, data of each frame image outputted at 150 fps from the image sensor 15 is acquired and then recorded. Therefore, in the case in which the slow motion movie recording is carried out, the postprocessing unit 51 is activated by the switching control unit 55 each time RAW data of one frame is written into the RAW buffer 61. This means that the postprocessing unit 51 sequentially reads RAW data of each frame image from the RAW buffer 61, converts the RAW data into YUV data, and sequentially writes the YUV data into the YUV buffer 62. Thus, YUV data of each frame image, i.e. the whole YUV data of frame images for the frame numbers 30 to 44 in the example of FIG. 1B, is acquired, to be written into the YUV buffer 62.

The JPEG encoding unit 52 sequentially reads YUV data for each frame image and encodes the YUV data according to the JPEG method. As a result, the YUV data is converted into so-called JPEG data to be written into the JPEG buffer 63.

The readout processing of YUV data of a frame image from the YUV buffer 62 by the JPEG encoding unit 52 is executed in parallel with the write processing of YUV data of another frame image into the YUV buffer 62 by the postprocessing unit 51 described above.

For this reason, in the present embodiment, the YUV buffer 62 has a dual configuration to control the write processing by the postprocessing unit 51 and the readout processing by the JPEG encoding unit 52 separately so as to avoid any conflict caused between them.

The sound input processing unit 53 continuously acquires sound signals outputted from the microphone 24 during the movie recording regardless of whether it is the normal movie recording or the slow motion movie recording, executes processing such as A/D conversion, and writes sound data thus acquired into the sound buffer 64.

The recording control unit 54 sequentially acquires JPEG data for each frame image from the JPEG buffer 63 and sound data from the sound buffer 64 and sequentially writes the data into the memory card 25 while monitoring the state of the JPEG buffer 63 and the sound buffer 64, so as to arrange the data of image and sound in a format according to a predetermined movie data format.

In the present embodiment, it is assumed that the recording rate in this case is 30 fps, in accordance with the example of FIG. 1.

The switching control unit 55 controls switching from one of normal movie recording and slow motion movie recording to the other thereof.

In the present embodiment, when the record button of the operation unit 23 is pressed, the switching control unit 55 starts to control the normal movie recording. This means that the switching control unit 55 activates the postprocessing unit 51 at intervals required for RAW data of 5 frames to be written into the RAW buffer 61, in accordance with the clock pulse of TG 17 shown FIG. 2 or the like, for example.

After that, when the user performs the switching operation using the operation unit 23, the switching control unit 55 switches from the normal movie recording to the slow motion movie recording and then controls the slow motion movie recording. This means that the switching control unit 55 activates the postprocessing unit 51 each time RAW data of one frame is written into the RAW buffer 61, in accordance with the clock pulse of TG 17 or the like of FIG. 2, for example.

After that, the switching control unit 55 switches from the slow motion movie recording to normal movie recording again, and controls the normal movie recording. This means that the switching control unit 55 activates the postprocessing unit 51 at intervals required for RAW data of 5 frames to be written into the RAW buffer 61 again.

In the following, from among processing executed by the image capturing device 1 thus constructed, processing for recording data of moving images (hereinafter referred to as “movie recording”) will be described.

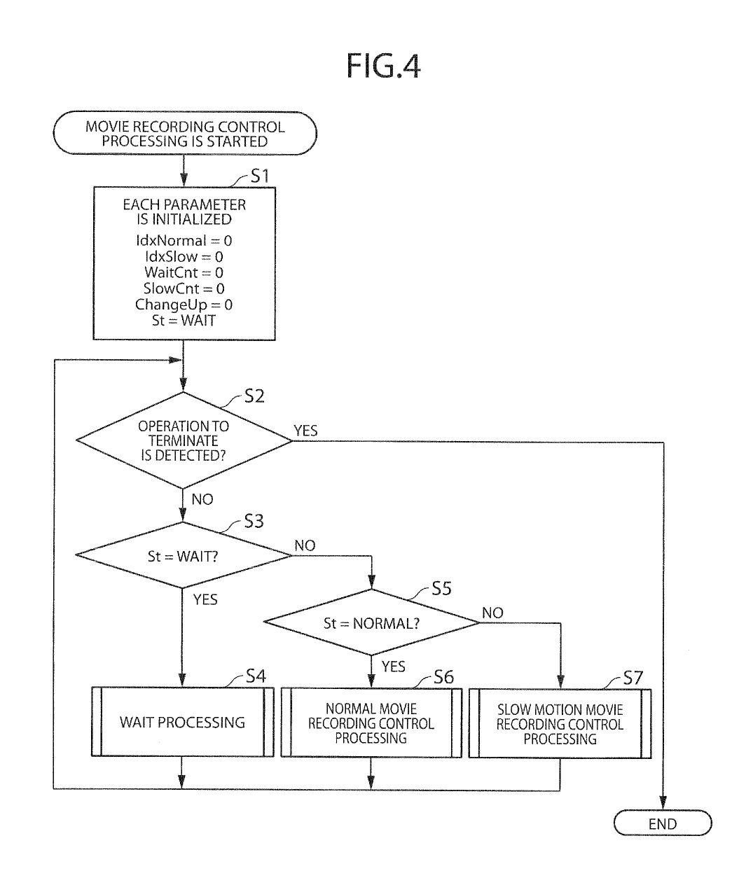

FIG. 4 is a flowchart showing one example of flow of processing for controlling the movie recording (hereinafter defined as “movie recording control processing”) executed by the switching control unit 55.

The movie recording control processing starts when, for example, the record button of the operation unit 23 is operated, and the CPU 20 interprets the operation as an instruction to start movie recording.

In step S1, the switching control unit 55 initializes each parameter. In the present embodiment, parameters of Id×Normal, Id×Slow, WaitCnt, SlowCnt, and ChangeUp are set to 0. The meaning of these parameters will be described later.

Also, a value “WAIT” indicating a wait state is set to a parameter St (hereinafter defined as “state St”) indicating a state of the movie recording control processing. As values of the state St, there are two other values including “NORMAL” indicating a state in which the normal movie recording is carried out and “SLOW” indicating a state in which the slow motion movie recording is carried out.

In step S2, the switching control unit 55 determines whether or not any operation to terminate the movie recording is detected. In the present embodiment, it is determined that the operation to terminate the movie recording is detected when the record button of the operation unit 23 is operated again. In such a case, the determination in step S2 is “YES”, and the movie recording control processing is terminated.

If, on the other hand, the record button of the operation unit 23 is not operated again, the determination in step S2 is “NO”, and control proceeds to step S3.

In step S3, the switching control unit 55 determines whether or not “WAIT” has been set to the state St (St=WAIT).

If “WAIT” has been set to the state St, the determination in step S3 is “YES”, and control proceeds to step S4.

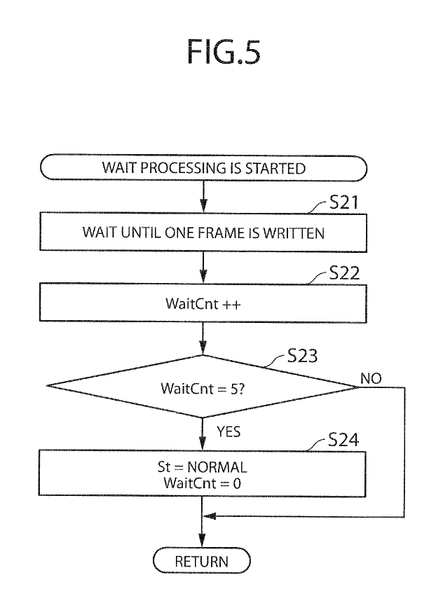

In step S4, the switching control unit 55 causes the movie recording to wait until RAW data of a predetermined number of frames is accumulated in the RAW buffer 61 (hereinafter defined as “wait processing”). The wait processing will be described later in detail with reference to the flowchart of FIG. 5. When the wait processing in step S4 is terminated, control goes back to step S2, and the processes thereafter are repeated.

When, on the other hand, “NORMAL” or “SLOW” has been set to the state St, the determination in step S3 is “YES”, and control proceeds to step S5.

In step S5, the switching control unit 55 determines whether or not “NORMAL” has been set to the state St (St=NORMAL).

Details will be described later with reference to the flowchart of FIG. 5, but in the present embodiment, the state St is changed from “WAIT” to “NORMAL” when RAW data of 5 frames is accumulated in the RAW buffer 61. In such a case, the determination in step S5 is “YES”, and control proceeds to step S6.

In step S6, the switching control unit 55 executes the control of the normal movie recording. This means that the switching control unit 55 activates the postprocessing unit 51 at intervals required for RAW data of 5 frames to be written into the RAW buffer 61.

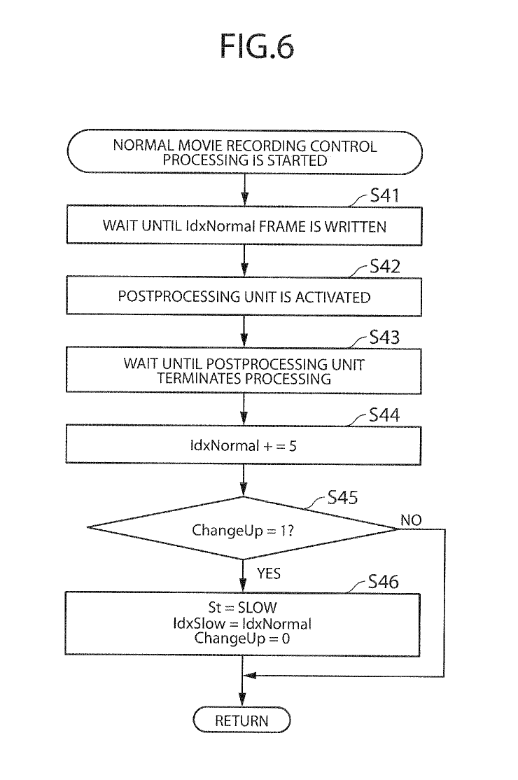

Such control processing is hereinafter defined as “normal movie recording control processing”. The normal movie recording control processing will be described later in detail with reference to the flowchart of FIG. 6.

When the normal movie recording control processing of step S6 is terminated, control goes back to step S2, and the processes thereafter are repeated.

Details will be described later with reference to the flowchart of FIG. 6, but in the present embodiment, the state St is changed from “NORMAL” to “SLOW” when a user operates the operation unit 23 and performs the switching operation during the normal movie recording. In such a case, the determination in step S5 is “NO”, and control proceeds to step S7.

In step S7, the switching control unit 55 switches from the normal movie recording to the slow motion movie recording and controls the slow motion movie recording. This means that the switching control unit 55 activates the postprocessing unit 51 each time RAW data of one frame is written into the RAW buffer 61.

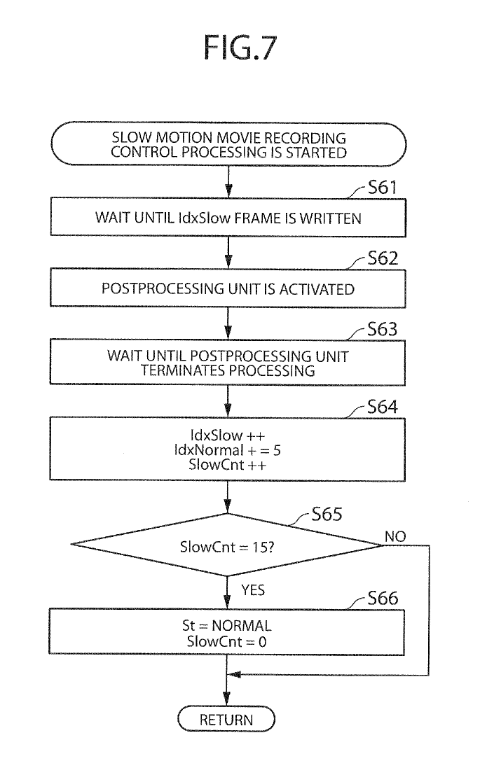

Such control processing is hereinafter defined as “slow motion movie recording control processing”. The slow motion movie recording control processing will be described later in detail with reference to the flowchart of FIG. 7.

When the slow motion movie recording control processing of step S7 is terminated, control goes back to step S2, and the processes thereafter are repeated.

In the following, in the movie recording control processing, the wait processing of step S4 will be described in detail. FIG. 5 is a flowchart showing one example of flow of the wait processing.

As described above, if “WAIT” has been set to the state St, YES is determined for the process of step S3, and the wait processing starts in the process of step S4.

In step S21, the switching control unit 55 executes processing for waiting until data of one frame image is written. This means that when RAW data of one frame is written into the RAW buffer 61, the process of step S21 is terminated and control proceeds to step S22.

In step S22, the switching control unit 55 increments a value of WaitCnt by 1 (WaitCnt++). Here, WaitCnt is a parameter that indicates a repeat count of the wait processing, i.e. the number of frame images stored as RAW data in the RAW buffer 61.

In step S23, the switching control unit 55 determines whether or not the value of WaitCnt is equal to 5.

If the value of WaitCnt is less than 5, i.e. if the number of frame images stored as RAW data in the RAW buffer 61 is less than 5, NO is determined for step S23, and the wait processing is terminated. This means that the process of step S4 of FIG. 4 is terminated, and control goes back to step S2 to repeat the processes thereafter.

Thus, loop processing of step S2: NO, step S3: YES, and step S4 is repeated until RAW data of 5 frames is stored in the RAW buffer 61, and the movie recording control processing remains in a wait state.

After that, when RAW data of 5 frames is stored in the RAW buffer 61, YES is determined for step S23, and control proceeds to step S24.

In step S24, the switching control unit 55 changes the state St from “WAIT” to “NORMAL” (St=NORMAL), and resets the value of WaitCnt to 0 (WaitCnt=0).

In this way, the wait processing is terminated. This means that the process of step S4 of FIG. 4 is terminated, and control goes back to step S2 and the processes thereafter are repeated.

This time, however, since “NORMAL” is set to the state St, NO is determined for the process of step S3, YES is determined for the process of step S5, and the normal movie recording control processing of step S6 is executed.

In the following, the normal movie recording control processing of step S6 is described in detail. FIG. 6 is a flowchart showing one example of detailed flow of the normal movie recording control processing.

In step S41, the switching control unit 55 executes processing for waiting until data of a frame image for the frame number Id×Normal is written.

Id×Normal is a parameter that indicates a frame number assigned to data of a frame image to be subsequently recorded in the normal movie recording.

Therefore, when RAW data of the frame image for the frame number Id×Normal is written in the RAW buffer 61, the process of step S41 is terminated, and control proceeds to step S42.

In step S42, the switching control unit 55 activates the postprocessing unit 51.

In step S43, the switching control unit 55 executes processing for waiting until the postprocessing unit 51 terminates the processing for the frame image data for the frame number Id×Normal.

The postprocessing unit 51 reads the RAW data of the frame for the frame number Id×Normal from the RAW buffer 61, converts the RAW data into YUV data, and writes the YUV data into the YUV buffer 62. With this, the process of step S43 is terminated, and control proceeds to step S44.

In step S44, the switching control unit 55 increments Id×Normal by 5 (ID×Normal+=5).

In step S45, the switching control unit 55 determines whether or not ChangeUp is equal to one. Here, ChangeUp is a switching flag that indicates permission or prohibition of switching from the normal movie recording to the slow motion movie recording. When the switching operation described above is performed, ChangeUp is switched from 0 to 1. If the value of ChangeUp is equal to 0, the switching from the normal movie recording to the slow motion movie recording is prohibited. On the other hand, if the value of ChangeUp is equal to 1, the switching from the normal movie recording to the slow motion movie recording is permitted.

Therefore, the value of ChangeUp remains equal to 0 until the user performs the switching operation by using the operation unit 23. In such a case, NO is determined for step S45, and the normal movie recording control processing is terminated.

This means that the process of step S6 of FIG. 4 is terminated, control goes back to step S2 and the processes thereafter are repeated.

Thus, unless the switching operation is performed, loop processing of step S2: NO, step S3: NO, step S5: YES, and step S6 is repeated, and the normal movie recording is carried out.

Each time the process of step S44 is repeated, Id×Normal is incremented by 5 as in 0, 5, 10, 15, 20, and 25. Therefore, as described with reference to FIG. 1B, each time the RAW data of the frame images for the frame numbers 0, 5, 10, 15, 20, and 25 is written into the RAW buffer 61, the postprocessing unit 51 is activated. As a result, YUV data of the frame images for the frame numbers 0, 5, 10, 15, 20, and 25 is acquired. Furthermore, JPEG data of the frame images for the frame numbers 0, 5, 10, 15, 20, and 25 is acquired through the JPEG encoding unit 52 and recorded in the memory card 25 via the recording control unit 54.

After that, if the switching operation is performed during the normal movie recording, ChangeUp is switched from zero to one. In such a case, YES is determined for step S45, and control proceeds to step S46.

In step S46, the switching control unit 55 switches the state St from “NORMAL” to “SLOW”, changes the value of Id×Slow to be equal to the value of Id×Normal (Id×Slow=Id×Normal), and resets ChangeUp to 0. What is meant by Id×Slow will be described later.

With this, the normal movie recording control processing is terminated. This means that the process of step S6 of FIG. 4 is terminated, control goes back to step S2, and the processes thereafter are repeated.

This time, however, since “SLOW” is set to the state St, NO is determined for the process of step S3, and then NO is determined for the process of step S5, and the slow motion movie recording control processing of step S7 is executed.

In the following, the slow motion movie recording control processing of step S7 will be described in detail. FIG. 7 is a flowchart showing one example of detailed flow of the slow motion movie recording control processing.

In step S61, the switching control unit 55 executes processing for waiting until data of a frame image for the frame number Id×Slow is written.

Here, Id×Slow is a parameter that indicates a frame number assigned to data of a frame image to be subsequently recorded in the slow motion movie recording. Therefore, if RAW data of the frame for the frame number Id×Slow is written into the RAW buffer 61, the process of step S61 is terminated, and control proceeds to step S62.

In step S62, the switching control unit 55 executes control to activate the postprocessing unit 51. In step S63, the switching control unit 55 executes processing for waiting until the postprocessing unit 51 terminates the processing for the frame image data for the frame number Id×Slow.

The postprocessing unit 51 reads the RAW data of the frame for the frame number Id×Slow from the RAW buffer 61, converts the RAW data into YUV data, and writes the YUV data into the YUV buffer 62. With this, the process of step S63 is terminated, and control proceeds to step S64.

In step S64, the switching control unit 55 increments Id×Slow by 1 (ID×Slow++), increments Id×Normal by 5 (Id×Normal+=5), and increments SlowCnt by 1 (SlowCnt++). Here, SlowCnt is a parameter that indicates a repeat count of the slow motion movie recording control processing, i.e. the number of frame images recorded as JPEG data in the memory card 25 in the slow motion movie recording.

In step S65, the switching control unit 55 determines whether or not SlowCnt is equal to 15. In the present embodiment, the total number of frame images to be recorded as JPEG data in the memory card 25 in the slow motion movie recording is 15, as described above.

Therefore, when the current number of frame images recorded as JPEG data in the memory card 25 in the slow motion movie recording is less than 15, NO is determined for step S65, and the slow motion movie recording control processing is terminated. This means that the process of step S7 of FIG. 4 is terminated, control goes back to step S2, and the processes thereafter are repeated.

Thus, when the switching operation is performed, loop processing of step S2: NO, step S3: NO, step S5: NO, and step S7 is repeated, and the slow motion movie recording is carried out.

Each time the process of step S64 is repeated, Id×Slow is incremented by 1. For example, it is assumed that the switching operation is performed at a state in which Id×Normal is equal to 30, Id×Slow is set to 30 in the process of step S46 of FIG. 6, and then the slow motion movie recording control processing is executed for the first time. In this case, Id×Slow is changed as in 30, 31, 32, and so forth.

As is described with reference to FIG. 1B, each time the RAW data of the frame images for the frame numbers 30, 31, 32, and so forth is written into the RAW buffer 61, the postprocessing unit 51 is activated. As a result, YUV data of the frame images for the frame numbers 30, 31, 32, and so forth is acquired. Furthermore, JPEG data of the frame images for the frame numbers 30, 31, 32, and so forth is acquired through the JPEG encoding unit 52 as a target for recording, and recorded in the memory card 25 via the recording control unit 54.

After that, as the slow motion movie recording continues, when the JPEG data of the 15th frame image, i.e. the frame image for the frame number 44 in the example of FIG. 1B, is recorded in the memory card 25, SlowCnt becomes equal to 15. In such a case, YES is determined for step S65, and control proceeds to step S66. In step S66, the switching control unit 55 switches the state St from “SLOW” to “NORMAL” again, and resets SlowCnt to 0.

With this, the slow motion movie recording control processing is terminated. This means that the process of step S7 of FIG. 4 is terminated, and control goes back to step S2. After that, unless the switching operation is performed again, loop processing of step S2: NO, step S3: NO, step S5: YES, and step S6 is repeated, and the normal movie recording is carried out again.

In this way, the switching control unit 55 executes the movie recording control processing shown in FIGS. 4 to 7, thereby enabling performance of the normal movie recording and the slow motion movie recording continuously.

During such movie recording, the recording control unit 54 continuously executes recording of the sound data into the memory card 25. This means that the sound data recording starts along with the movie recording control processing when an instruction to start the movie recording is issued as a result of an operation of the record button of the operation unit 23, for example. After that, the processing for sound data recording continues separately, regardless of whether or not the switching operation is performed, i.e. whether or not the normal movie recording is switched to the slow motion movie recording.

The image capturing apparatus 1 can play back the data of moving images and sound thus recorded in the memory card 25. In such a case, playback rate of the data of moving images is normal speed of 30 fps, as is described above. Therefore, moving images recorded in slow motion movie recording period are played back at a rate 5 times as slow as the capture rate, and the remaining moving images, i.e. moving images recorded in the normal movie recording period, are played back at a normal rate. The sound is played back continuously regardless of whether the moving images are played back at slow speed or at normal speed.

As described above, the image capturing apparatus 1 according to the present embodiment is provided with:

an image sensor 15 that captures a subject and outputs data of a frame image including the subject;

a microphone 24 that inputs sound; and a CPU 20 that executes a control to record data of a plurality of frame images outputted from the image sensor 15 as data of moving images in a memory card 25 by normal movie recording or slow motion movie recording, as well as to record data of sound inputted to the microphone 24, in the memory card 25.

The CPU 20 can execute:
control of the slow motion movie recording, which records data of frame images outputted from the image sensor 15 in a predetermined slow motion movie capture period (a first capture period) in the memory card 25 within a slow motion movie recording period (a first recording period) set according to the slow motion movie capture period;
control of the normal movie recording, which records data of frame images outputted from the image sensor 15 in a period (a second capture period) other than the slow motion movie capture period, in the memory card 25 within the normal movie recording period (a second recording period); and
control of recording sound data, which continuously records sound data in the memory card 25 through the slow motion period and the normal movie recording period.

Hence, it becomes possible to maintain continuity in recording and playing back sound data even if the normal movie recording and slow motion movie recording are carried out continuously. This means that it becomes possible to play back moving images with an effect of slow motion movie recording while maintaining continuity of playing back sound by normal play back.

### Second Embodiment

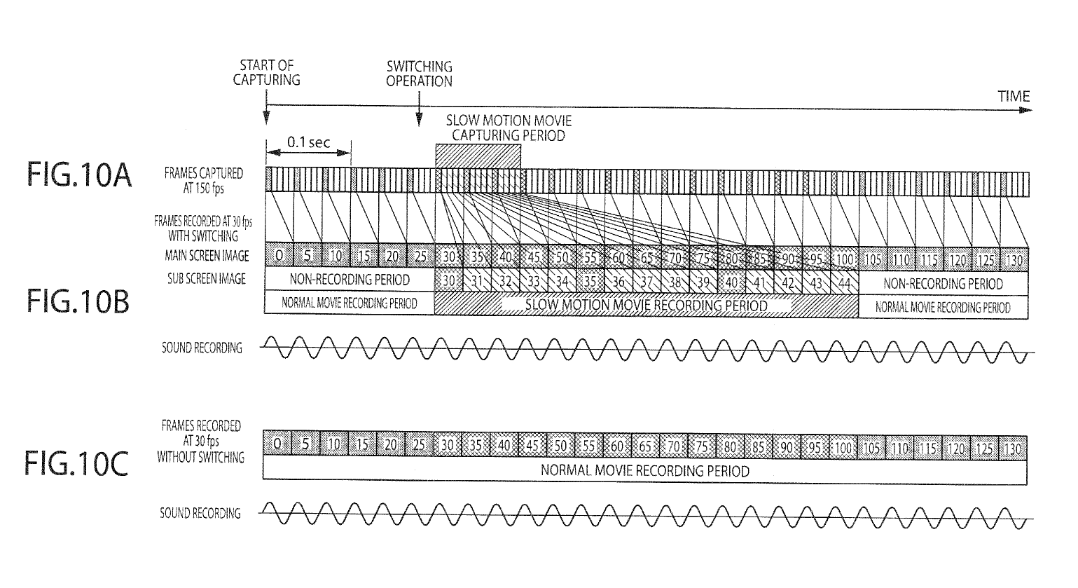

In the following, a second embodiment of the present invention will be explained with reference to FIGS. 10 to 14. In the present embodiment, the slow motion movie recording is executed to record data of frame images captured at Y fps (Y is an arbitrary number) and outputted in a predetermined slow motion movie capture period (a first capture period) by an image sensor 15. At the same time, data of composite images including data of sub screen images captured at Y fps in the slow motion movie capture period and data of main screen images captured at X fps (X is an arbitrary number less than Y) in the slow motion movie recording period (a first recording period) determined in accordance with the slow motion movie capture period, is recorded in the memory card 25 as data of composite moving images to be played back at X fps. The second embodiment is different from the first embodiment in this point.

An outline of the present embodiment will be explained with reference to FIG. 10.

FIG. 10 is a set of timing charts respectively illustrating relations between data of frame images captured and recorded as data of moving images and sound data in a case in which the normal movie recording and the slow motion movie recording are continuously carried out by an image capturing apparatus to which the present invention is applied.

FIG. 10A is a timing chart illustrating data of frame images outputted from an image capturing device. In FIG. 10A, a box denotes data of a frame image outputted from the image capturing device. Frame numbers are not shown in each box, but data of the leftmost frame image is numbered 0, and in a direction from left to right, i.e. in an order of output from the image capturing device, data of each frame image has a frame number that is incremented by 1, as in 1, 2, 3, and so forth. In the example of FIG. 10A, for ease of comparison with the conventional capture rate, the capture rate is assumed to be 150 fps, which is identical to those of the conventional examples shown in FIGS. 8A and 9A described above.

FIG. 10B is a timing chart respectively illustrating data of frame images and sound recorded in a storage medium in a case in which the slow motion movie recording is carried out between normal movie recordings. In FIG. 10B, a box in the line of “main screen images” denotes data of one of frame images for a main screen to be included in the composite images recorded in the storage medium at 30 fps. Also, a box in the line of “sub screen images” denotes one of frame images for a sub screen to be included in the composite images recorded in the storage medium at 30 fps. A number described in each box indicates a frame number assigned to the data of the frame image denoted by the corresponding box in the line of “frames captured at 150 fps”. The same applies to the numbers in boxes of FIG. 10C, which will be described later.

In a case of normal movie recording, as shown in FIG. 10B, from data of frame images outputted from the image capturing device, data of frame images at 5-frame intervals (respectively denoted by the black boxes in FIG. 10A), i.e. data of frame images for the frame numbers 0, 5, 10, 15, 20, and 25 is acquired and then recorded in the storage medium.

During such normal movie recording, a user can perform the switching operation to switch from normal movie recording to the slow motion movie recording. When such switching operation is performed, the normal movie recording is switched to the slow motion movie recording, and data of frame images outputted from the image capturing device is sequentially recorded in the storage medium under the following condition. When the capture rate is 150 fps and recording rate is 30 fps, the slow motion movie capture period is 0.1 second per one switching operation (i.e. the number of frames to be recorded in the slow motion movie recording is 15). In this slow motion movie capture period, data of sub screen images is acquired at a frame rate five times faster than in the normal movie capture period. Simultaneously, from data of frame images outputted from the image capturing device, data of frame images at 5-frame intervals (denoted by the shaded boxes in FIG. 10A), i.e. data of frame images for the frame numbers 30, 35, 40, 45, 50, 55, . . . 100 is acquired as data of main screen images in the slow motion movie recording period corresponding to the slow motion movie capture period. The data of sub screen images thus acquired is combined with the data of main screen images, and thus, data of composite images having two screens is generated and recorded.

More specifically, in the example of FIG. 10, the switching operation is performed at the moment when data of the frame image for the frame number 26 is outputted from the image capturing device. At the moment when this switching operation is performed, the recording of data of the frame image for the frame number 25 is still in progress. Therefore, the actual switching from the normal movie recording to the slow motion movie recording takes place after the recording of data of the frame image for the frame number 25 is complete. This means that the slow motion movie recording starts with data of a frame image outputted from the image capturing device at the moment when the switching is complete, i.e. data of a frame image for the frame number 30, 5 frames after the frame number 25.

As described above, since the slow motion movie capture period is 0.1 second per one switching operation, i.e. the number of frames to be recorded in the slow motion movie recording is 15, as shown in FIG. 1B, data of frame images for each of the frame numbers 30 to 44 becomes a target for recording in the slow motion movie recording for a sub screen image. Therefore, when the slow motion movie recording is started, data of each frame image outputted from the image capturing device, i.e. data of the all frame images for the frame numbers 30, 31, 32, 33, . . . 44 is acquired as data of sub screen images.

Simultaneously, from data of frame images outputted from the image capturing device, data of frame images at 5-frame intervals (denoted by the shaded boxes in FIG. 10A), i.e. data of frame images for the frame numbers 30, 35, 40, 45, 50, 55, . . . 100 is acquired as data of main screen images. The data of sub screen images thus acquired is combined with data of main screen images, and as a result thereof, data of 30 fps composite images having two screens is generated and recorded.

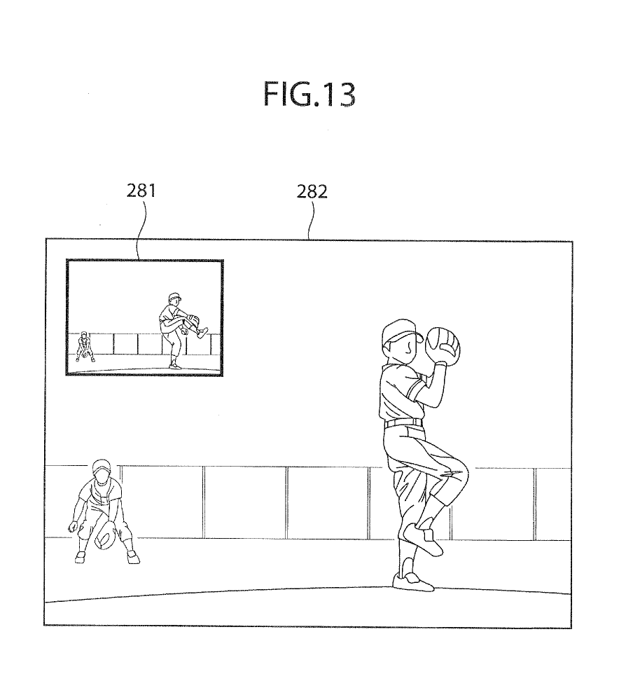

FIG. 13 is a diagram showing an example of two screen composite images recorded in the slow motion movie recording control processing as a composite screen including “moving images captured at 150 fps” as a sub screen 281 and “moving images equivalent to be captured at 30 fps” as a main screen 282. In FIG. 13, an image of a pitcher is played back separately in the main screen 282, in which an image of the pitcher is played back by normal playback, and in the sub screen 281, in which an image of the pitcher is played back by slow playback.

Next, at a moment when the movie recording is switched to the normal movie recording again, as shown in FIG. 10B, data of the frame image for the frame number 105 is outputted from the image capturing device. In this case, data of frame images up to this moment is recorded as data of main screen images. After that, data of frame images for each of the frame numbers 105, 110, 115, 120, 125, 130, and so forth is acquired as a target for recording one screen image and recorded in the storage medium.

As shown in FIG. 10A, the time period in which data of composite images including data of 75 continuous frame images as sub screen image data and data of 15 frame images, which are acquired by frame-skipping the continuous 75 frame images to pick one fifth of the frame images as main screen image data, are recorded in the storage medium, is defined as “slow motion movie recording period”. This slow motion movie recording period is determined in accordance with the slow motion movie capture period. In the example of FIG. 10B, the slow motion movie recording period is 5 times longer than 0.1 second of the slow motion movie capture period, i.e. 0.5 seconds.

Also, the time period in which data of frame images is recorded by the normal movie recording is hereinafter defined as “normal movie recording period” as shown in FIG. 10A. This period is regarded as a “non-recording period” for a sub screen, in which no image data is recorded for the sub screen.

Here, sound data is continuously recorded in the storage medium regardless of whether in the slow motion movie recording period or in the normal movie recording period, as shown in FIG. 10B. As a result, even when the slow motion movie recording is followed by the normal movie recording, continuity of recording and playing back of sound data is maintained.

FIG. 10C is a timing chart illustrating data of frame images and sound recorded in the storage medium in a case in which no switching operation is performed, i.e. the normal movie recording is consistently carried out. In this case, the whole period of movie recording from the start to the termination becomes the normal movie recording period without having any slow motion movie recording period.

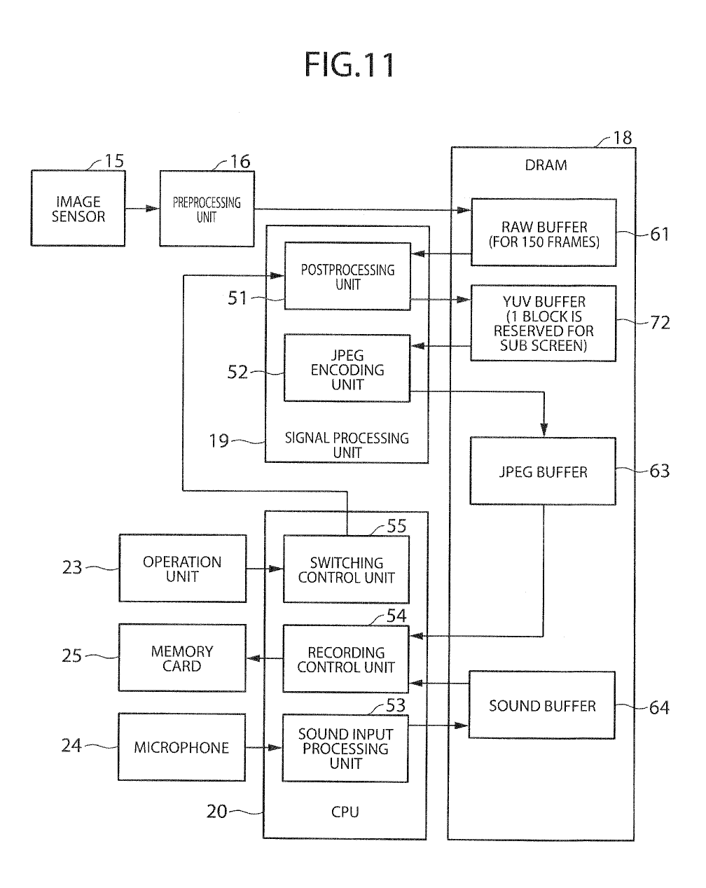

In the following, a configuration of an image capturing apparatus according to the second embodiment is explained with reference to FIG. 11.

FIG. 11 is a functional block diagram showing a functional configuration to implement normal movie recording and slow motion movie recording according to the second embodiment. An image capturing apparatus according to the second embodiment can be implemented with a configuration almost the same as the image capturing apparatus 1 according to the first embodiment. Therefore, the constitutional elements the same as those of the image capturing apparatus 1 according to the first embodiment are identically numbered and explanation thereof is omitted, with only characteristic elements being explained.

Both of the image sensor 15 and the preprocessor 16 operate at a rate equal to the capture rate. In the example of FIG. 10, the image sensor 15 executes image capturing at 150 fps, and the preprocessor 16 executes preprocessing at 150 fps.

Data of frame images outputted from the preprocessing unit 16 is data of RAW images, i.e. RAW data, to be written into the RAW buffer 61 of DRAM 18. This RAW buffer 61 is a ring buffer with capacity for RAW data of 150 frames. Also, the destination address in the RAW buffer 61 where the output data from the preprocessing unit 16 is written is relocated in turn for each frame image.

The activation timing of the postprocessing unit 51 is controlled by the switching control unit 55. For example, in a case in which the normal movie recording is carried out, as explained with reference to FIG. 10, from data of frame images outputted from the image sensor 15 at 150 fps, data of frame images at 5-frame intervals is acquired, and then recorded. Therefore, in the case in which the normal movie recording is carried out, the postprocessing unit 51 is activated by the switching control unit 55 at intervals required for RAW data of 5 frames to be written into the RAW buffer 61. This means that the postprocessing unit 51 sequentially reads RAW data of one frame from the RAW buffer 61 at 5-frame intervals, converts the RAW data into YUV data, and writes the YUV data into the YUV buffer 72. Thus, YUV data of frame images at 5-frame intervals, i.e. the YUV data for the frame numbers 0, 5, 10, 15, 20, and 25 in the example of FIG. 10B, is acquired as a target for recording, and written into the YUV buffer 72.

On the other hand, in a case in which the slow motion movie recording is carried out, for example, as described with reference to FIG. 10, data of each frame image outputted at 150 fps from the image sensor 15 is acquired and then recorded for sub screen images. Therefore, in the case in which the slow motion movie recording is carried out, the postprocessing unit 51 is activated by the switching control unit 55 each time RAW data of one frame is written into the RAW buffer 61. This means that the postprocessing unit 51 sequentially reads RAW data of each frame image from the RAW buffer 61, converts the RAW data into YUV data, and sequentially writes the YUV data into the YUV buffer 72. Thus, YUV data of each frame image, i.e. the whole YUV data for the frame numbers 30 to 44 in the example of FIG. 10B, is acquired to be written into the YUV buffer 72 as data of sub screen images. Simultaneously, the postprocessing unit 51 sequentially reads RAW data of each 5th frame from the RAW buffer, converts the RAW data into YUV data, and writes the YUV data into the YUV buffer 72 as data of main screen images.

The JPEG encoding unit 52 sequentially reads YUV data for each frame image and encodes the YUV data according to the JPEG method. As a result, the YUV data of the frame image is converted into so-called JPEG data and written into the JPEG buffer 63.

The readout processing of YUV data of a frame image from the YUV buffer 72 by the JPEG encoding unit 52 is executed in parallel with the write processing of YUV data of another frame image into the YUV buffer 72 as data of main screen image and the write processing of YUV data of still another frame image into the YUV buffer 72 as data of sub screen image by the postprocessing unit 51 described above. Therefore, the YUV buffer 72 includes a storage area to write data of main screen images and composite images, a storage area for the JPEG encoding unit 52 to read, and a storage area to write data of sub screen images. Each storage area is controlled so as to avoid conflict among the write processing of data of main images and composite images by the postprocessing unit 51, the write processing of data of sub screen images by the postprocessing unit 51, and the readout processing by the JPEG encoding unit 52 by appropriately switching the storage areas in the YUV buffer 72 in turn.

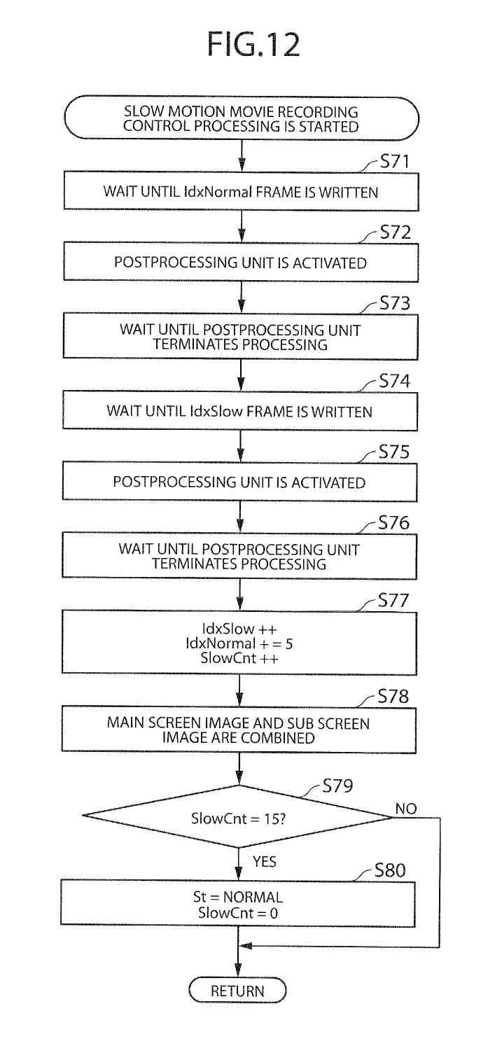

In the following, the slow motion movie recording control processing will be explained in detail. FIG. 12 is a flowchart showing one example of detailed flow of the slow motion movie recording control processing.

In the present embodiment, it is assumed that the switching operation to the slow motion movie recording is performed when the shutter button is pressed. This means that in step S5 of the movie recording control processing of FIG. 4 described above, when the switching control unit 55 determines that a user has pressed the shutter button, the slow motion movie recording control processing is started.

In step S71, the switching control unit 55 executes processing for waiting until data of a frame image for the frame number Id×Normal is written. Id×Normal is a parameter that indicates a frame number assigned to data of the frame image to be subsequently recorded for a main screen image in the slow motion movie recording control processing.

Therefore, when RAW data of the frame for the frame number Id×Normal is written into the RAW buffer 61, the process of step S71 is terminated, and control proceeds to step S72.

In step S72, the switching control unit 55 executes control to activate the postprocessing unit 51. In step S73, the switching control unit 55 executes processing for waiting until the postprocessing unit 51 terminates the processing for data of the frame image for the frame number Id×Normal.

The postprocessing unit 51 reads the RAW data of the frame image for the frame number Id×Normal from the RAW buffer 61, converts the RAW data into YUV data, and writes the YUV data thus converted into the storage area reserved for data of a main screen image and a composite image in the YUV buffer 72. With this, the process of step S73 is terminated, and control proceeds to step S74.

In step S74, the switching control unit 55 executes processing for waiting until data of a frame image for the frame number Id×Slow is written. Id×Slow is a parameter that indicates a frame number assigned to data of the frame image to be subsequently recorded for a sub screen image in the slow motion movie recording control processing.

Therefore, when the RAW data of the frame image for the frame number Id×Slow is written into the RAW buffer 61, the process of step S74 is terminated, and control proceeds to step S75.

In step S75, the switching control unit 55 executes a control to activate the postprocessing unit 51. In step S76, the switching control unit 55 executes processing for waiting until the postprocessing unit 51 terminates the processing for data of the frame image for the frame number Id×Slow.

The postprocessing unit 51 reads the RAW data of the frame image for the frame number Id×Slow from the RAW buffer 61, converts the RAW data into YUV data, and writes the YUV data thus converted into the storage area reserved for data of a sub screen image in the YUV buffer 72. With this, the process of step S76 is terminated, and control proceeds to step S77.

In step S77, the switching control unit 55 increments Id×Slow by 1 (Id×Slow++), increments Id×Normal by 5 (Id×Normal+=5), and increments SlowCnt by 1 (SlowCnt++).

In step S78, the switching control unit 55 combines data of a main screen image and data of a sub screen image. This means that the switching control unit 55, by way of a PinP (Picture in Picture) method, reduces the size of the sub screen image of data written in the YUV buffer 72 by the postprocessing unit 51 activated in step S75, and embeds the data of the thus reduced size of the sub screen image into the main screen image written in the YUV buffer 72 by the postprocessing unit 51 activated in step S72.

In step S79, the switching control unit 55 determines whether or not SlowCnt is equal to 15, since the total number of frame images to be recorded in the memory card 25 as JPEG data by the slow motion movie recording is 15 as described earlier. In a case in which the current number of frame images recorded in the memory card 25 as JPEG data by the slow motion movie recording is less than 15, NO is determined in step S79, and the slow motion movie recording control processing is terminated.

In this case, in the movie recording control processing of FIG. 4, loop processing of step S2: NO, step S3: NO, step S5: NO, and step S7 is repeated, and the slow motion movie recording is carried out until the total number of frame images recorded by the slow motion movie recording becomes 15.

Each time the process of step S77 is repeated, Id×Slow is incremented by 1. For example, when the switching operation is performed at a state in which Id×Normal is equal to 30, Id×Slow is set to 30 in the process of step S46 of FIG. 6, and then the slow motion movie recording control processing is executed for the first time. In this case, Id×Slow is being changed as in 30, 31, 32, and so forth.

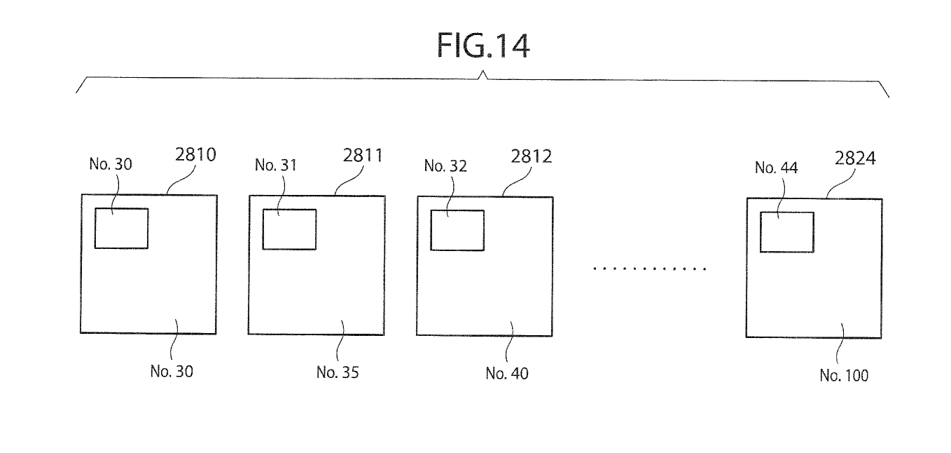

FIG. 14 is a diagram showing an example of composite moving images generated by the slow motion movie recording control processing. As is described with reference to FIG. 10B, each time RAW data of one frame for the frame numbers 30, 31, 32, and so forth is written in the RAW buffer 61, the postprocessing unit 51 is activated. Furthermore, each time RAW data of one frame for the frame numbers 30, 35, 40, and so forth is written in the RAW buffer 61, the postprocessing unit 51 is activated. As a result, as shown in FIG. 14, YUV data of the frame images 2810, 2811, 2812, . . . 2824 for composite images is acquired by reducing the size of each of frame images of YUV data for the frame numbers 30, 31, 32, . . . 44 for sub screen image and by embedding the YUV data of the thus reduced size of frame images into the YUV data of frame images for the frame numbers 30, 35, 40, . . . 100 for main screen images, respectively. Furthermore, JPEG data of the frame images 2810, 2811, 2812, . . . 2814 for composite images is acquired and recorded in the JPEG buffer 63 and the memory card 25 via the recording control unit 54.

After that, as the slow motion movie recording continues, when the JPEG data of the 15th frame image, i.e. the frame image 2824 in the example of FIG. 14, is recorded in the memory card 25, SlowCnt becomes equal to 15. At this moment, YES is determined for step S79, and control proceeds to step S80. In step S80, the switching control unit 55 switches the state St from “SLOW” to “NORMAL” again, and resets SlowCnt to 0. With this, the slow motion movie recording control processing is terminated.

In this case, unless switching operation is performed again while the movie recording control processing of FIG. 4, loop processing of step S2: NO, step S3: NO, step S5: YES, and step S6 is repeated, and the normal movie recording is carried out again.

In this way, whenever the slow motion movie recording control processing shown in FIG. 12 is carried out by the switching control unit 55, the normal movie recording for main screen, the slow motion movie recording for sub screen, and a composition of main screen images and the sub screen images are continuously executed.

During such movie recording, the recording control unit 54 continuously records sound data in the memory card 25. The sound data recording starts along with the movie recording control processing when an instruction to start movie recording is inputted by a full press operation of the record button of the operation unit 23, for example. After that, the processing for sound data recording continues separately, regardless of whether or not the normal movie recording is switched to the slow motion movie recording.

When the image capturing apparatus 1 plays back data of moving images and sound recorded in the memory card 25, normal playback rate of the data of moving images is 30 fps, as described above. Therefore, the sub screen images recorded in the slow motion movie recording period are played back at a rate five times as slow as the capture rate, and the remaining moving images, i.e. the main screen images recorded in normal movie recording period, are played back at a normal rate. The sound data is continuously played back regardless of whether the data of moving images is played back at slow speed or at normal speed.

As described above, the image capturing apparatus 1 according to the present embodiment is provided with:
an image sensor 15 that outputs data of a frame image including a subject by capturing the subject;
a microphone 24 that inputs sound; and
a CPU 20 that executes control to record data of a plurality of frame images outputted from the image sensor 15 by normal movie recording or slow motion movie recording as data of moving images, in a memory card, as well as to record sound data inputted in the microphone 24 in the memory card 25.

CPU 20 can execute:
control of slow motion movie recording, which records data of composite moving images of first screen images and second screen images in the memory card 25 (storage medium), the first screen images being expressed by data of frame images captured at Y fps (150 fps) continuously outputted from the image capturing unit in a predetermined slow motion movie capture period (a first capture period), and the second screen images being expressed by data of frame images acquired by skipping some of the frame images continuously outputted from the image capturing unit at a predetermined time interval so as to be played back at X fps in a first recording period in which data of the first screen images is recorded to be played back at X fps;
control of normal movie recording, which records in the memory card 25 data of frame images outputted from the image capturing unit in a second capture period that is different from the first capture period within a second recording period that is different from the first recording period (i.e. the second capture period is identical to the second recording period); and
control of sound data recording, which continuously records sound data in the memory card 25 through the first and the second recording periods.

As described above, in the present embodiment, the slow motion movie recording control processing executed during the normal movie recording performs control to combine information of moving images recorded by the slow motion movie recording as a sub screen into information of moving images recorded by the normal movie recording as a main screen, and control to record sound data continuously. As a result, it becomes possible to play back moving images with an effect of a slow motion movie recording while maintaining continuity in playing back sound and moving images at a normal rate.

Although it has been described in the above that information of moving images recorded by the slow motion movie recording as a sub screen and information of moving images recorded by the normal movie recording as a main screen are combined and recorded, the present invention is not limited to this. For example, information of moving images recorded by the slow motion movie recording as a main screen and information of moving images recorded by the normal movie recording as a sub screen may be combined and recorded. More specifically, in step S78, the switching control unit 55 can reduce the size of the main screen image of data written in the YUV buffer 72 by the postprocessing unit 51 activated in step S75, and embeds the data of the thus reduced size of the main screen image into the sub screen image written in the YUV buffer 72 by the postprocessing unit 51 activated in step S72. With this, seeing a normal speed moving images on a sub screen, a user can look thoroughly at slow motion moving images in the main screen.

It should be noted that the present invention is not limited to the embodiments described above, and modifications and improvements thereto within the scope in which an object of the present invention can be realized, are included in the invention.

For example, in the embodiments described above, although data of moving image (a plurality of frame images) captured after the switching operation has been described as being a target for the slow motion movie recording, the present invention is not limited to this. For example, the image capturing apparatus according to the present invention can have a specifying unit, though not illustrated, for specifying a target for the slow motion movie recording, i.e. a slow motion movie recording period, after a capture operation is complete. There is no limitation to a specifying method therefor. The specifying unit may automatically specify the period, or a user may specify the period by operating the operation unit 23. In this case, the slow motion movie recording control processing may be repeated unless the slow motion movie recording period is specified by the specifying unit by determining, for example, whether or not the operation of the specifying unit is released, instead of whether or not SlowCnt is equal to 15 in step S65 of the first embodiment. Similarly, in the second embodiment, the slow motion movie recording control processing may be repeated unless the slow motion movie recording period is specified by determining, for example, whether or not the operation of the specifying unit is released, instead of whether or not SlowCnt is equal to 15 in step S79.

In this case, the image capturing apparatus 1 temporarily records all of the data of moving images outputted from the image sensor 15 at 150 fps in the memory card 25, DRAM 18, or the like. The specifying unit specifies frame images to be recorded by the slow motion movie recording after the image sensor 15 completes a capture operation. Then, the image capturing apparatus 1 may generate a file of moving images and delete data of frame images, which are not specified as targets for the slow motion movie recording.

Alternatively, in the embodiments described above, although data of moving images (a plurality of frame images) captured after the switching operation has been described to be a target for the slow motion movie recording, the present invention is not limited to this. For example, by always delaying for a predetermined time the processing of the postprocessing unit 51 and after, data of moving images captured before the switching operation may be included in the target for the slow motion movie recording.

Furthermore, it has been described that the image capturing apparatus according to the present invention is configured by a digital camera. However, the present invention is not limited to a digital camera and can be applied to any electronic device having functions for capturing and recording moving images and for inputting and recording sounds. More specifically, the present invention can be applied to a video camera, a portable navigation device, a portable game device, and the like.

The series of processing described above can be executed by hardware and also can be executed by software.

In a case in which the series of processing is to be executed by software, the program configuring the software is installed from a network or a storage medium in a computer or the like. The computer may be a computer incorporated in dedicated hardware. Alternatively, the computer may be a computer capable of executing various functions by installing various programs, i.e. a general-purpose personal computer, for example.

The storage medium containing the program can be configured not only by removable media (e.g. the memory card 25 of FIG. 2) distributed separately from the device main body for supplying the program to a user, but also by a storage medium or the like supplied to the user in a state incorporated in the device main body in advance. The removable media is composed of a magnetic disk (including a floppy disk), an optical disk, a magnetic optical disk, or the like, for example. The optical disk is composed of a CD-ROM (Compact Disk-Read Only Memory), a DVD (Digital Versatile Disk), and the like. The magnetic optical disk is composed of an MD (Mini-Disk) or the like. The storage medium supplied to the user in the state incorporated in the device main body in advance includes the ROM 22 in FIG. 2 storing the program, a hard disk, not illustrated, and the like, for example.

It should be noted that, in the present description, the step describing the program stored in the storage medium includes not only the processing executed in a time series following this order, but also includes processing executed in parallel or individually, which is not necessarily executed in a time series.

What is claimed is:

1. An image capturing apparatus, comprising:
an image capturing unit;
a sound input unit that inputs sound;
a first acquisition unit that acquires, as a first group of images, a plurality of images of a subject continuously captured by the image capturing unit within a first recording period at a first frame rate by skipping some of the plurality of images of a subject at a predetermined time interval;
a second acquisition unit that acquires, as a second group of images, images of a subject continuously captured by the image capturing unit within a second recording period at a second frame rate ; and
a generating unit that generates moving images capable of being played back at the first frame rate based on the sound inputted by the sound input unit, the first group of images acquired by the first acquisition unit, and the second group of images acquired by the second acquisition unit.

2. An image capturing apparatus as set forth in claim 1, further comprising a switching unit that switches from one of the first acquisition unit and the second acquisition unit to another, while the one of the first acquisition unit and the second acquisition unit acquires an image of a subject.

3. An image capturing apparatus as set forth in claim 1, further comprising a specifying unit that specifies the second recording period based on a moving image stored in a storage medium.

4. An image capturing apparatus as set forth in claim 1, wherein
the first frame rate is X fps, and the second frame rate is Y fps, wherein
X is an arbitrary number, and Y is any number greater than X.

5. An image capturing control method comprising:
an image capturing step of capturing an image;
a sound input step of inputting sound;
a first acquisition step of acquiring, as a first group of images, a plurality of images of a subject continuously captured in the image capturing step within a first recording period at a first frame rate by skipping some of the plurality of images of a subject at a predetermined time interval;
a second acquisition step of acquiring, as a second group of images, images of a subject continuously captured in the image capturing step within a second recording period at a second frame rate; and
a generating step of generating moving images capable of being played back at the first frame rate based on the sound inputted in the sound input step, the first group of images acquired in the first acquisition step, and the second group of images acquired in the second acquisition step.

6. A storage medium having stored therein a program readable by a computer provided with an image capturing unit and a sound input unit that inputs sound, to cause the computer to function as:
a first acquisition unit that acquires, as a first group of images, a plurality of images of a subject continuously captured by the image capturing unit within a first recording period at a first frame rate by skipping some of the plurality of images of a subject at a predetermined time interval;
a second acquisition unit that acquires, as a second group of images, images of a subject continuously captured by the image capturing unit within a second recording period at a second frame rate; and
a generating unit that generates moving images capable of being played back at the first frame rate based on the sound inputted by the sound input unit, the first group of images acquired by the first acquisition unit, and the second group of images acquired by the second acquisition unit.
